(19) United States
(12) Patent Application Publication
(10) Pub. No.: US 2026/0182647 A1
(43) Pub. Date: Jul. 2, 2026

(54) AEROSOL GENERATION DEVICE

(71) Applicant: KT&G CORPORATION, Daejeon (KR)

(72) Inventors: Youngmin WOO, Seoul (KR); Sangjoon KIM, Yongin-si (KR); Sungwook YOON, Suwon-si (KR); Minju HAN, Seoul (KR)

(73) Assignee: KT&G CORPORATION, Daejeon (KR)

(21) Appl. No.: 19/345,162

(22) Filed: Sep. 30, 2025

(30) Foreign Application Priority Data
Dec. 26, 2024 (KR) 10-2024-0196919

(51) Int. Cl. A24F 40/46; A24F 40/53; A24F 40/57; A24F 40/60; H05B 6/68; H05B 6/80

(52) U.S. Cl. CPC A24F 40/46; A24F 40/53; A24F 40/57; A24F 40/60; H05B 6/68; H05B 6/80

(57) ABSTRACT

Disclosed is an aerosol generation device. An aerosol generation device according to an embodiment of the disclosure may include a housing including an insertion space into which an aerosol-generating article is insertable, a radiating unit configured to radiate electromagnetic waves into the insertion space to heat the aerosol-generating article, and a processor. Based on a control of the processor, the aerosol generation device is configured to block the electromagnetic waves when a frequency of the insertion space deviates from a preset resonant frequency band.

### CROSS-REFERENCE TO RELATED APPLICATION(S)

This application is based on and claims priority under 35 U.S.C. 119 to Korean Patent Application No. 10-2024-0196919, filed on Dec. 26, 2024, in the Korean Intellectual Property Office, the disclosure of which is herein incorporated by reference in its entirety.

### TECHNICAL FIELD

Various embodiments of the disclosure relate to a safer, dielectrically heated aerosol generation device.

### BACKGROUND

Recently, research has been underway to develop aerosol generation devices using dielectric heating. Dielectric heating is an efficient heating method that uses electromagnetic waves to heat aerosol-generating articles.

However, dielectric heating-type aerosol generation devices pose a serious safety risk due to unintended electromagnetic waves if the frequency in the insertion space associated with the aerosol-generating article falls outside the resonant frequency band.

### SUMMARY

The present invention may be devised to provide an aerosol generating device configured to prevent safety accidents through a frequency out-of-detection (FOD) function of halting electromagnetic wave radiation or outputting a warning when an event exceeding the resonant frequency band occurs in a dielectric heating-type aerosol generation device.

The challenges the disclosure aims to address are not limited to those mentioned above, and other challenges not mentioned will be readily apparent to those skilled in the art from the description below.

An aerosol generation device according to an embodiment of the disclosure may include a housing including an insertion space into which an aerosol-generating article is insertable, a radiating unit configured to radiate electromagnetic waves into the insertion space to heat the aerosol-generating article, and a processor. Based on a control of the processor, the aerosol generation device is configured to block the electromagnetic waves when a frequency of the insertion space deviates from a preset resonant frequency band.

A control method according to an embodiment of the disclosure is a control method for an aerosol generation device including a housing including an insertion space into which an aerosol-generating article is insertable, a radiating unit, and a processor, which may include radiating electromagnetic waves into the insertion space to heat the aerosol-generating article, and blocking the electromagnetic waves when a frequency of the insertion space deviates from a preset resonant frequency band.

According to the embodiments of the disclosure, it is possible to effectively prevent electromagnetic wave exposure and safety accidents by blocking electromagnetic waves when the frequency in the insertion space of the dielectric heating-type aerosol generation device exceeds the resonant frequency band.

The effects obtainable from the disclosure are not limited to those mentioned above, and other effects not mentioned will be clearly understood by those skilled in the art from the description below.

### BRIEF DESCRIPTION OF THE DRAWINGS

The above and other aspects, features, and advantages of the disclosure will be more apparent from the following detailed description taken in conjunction with the accompanying drawings, in which:

FIG. 1 is a block diagram of an aerosol generation device according to an embodiment;

FIG. 2 is an exemplary diagram of an aerosol generation device according to an embodiment;

FIG. 3 is a flowchart illustrating a control operation of an aerosol generation device according to an embodiment;

FIG. 4 is a flowchart illustrating a control operation of an aerosol generation device according to an embodiment;

FIG. 5 is a flowchart illustrating an operation of blocking electromagnetic waves according to an embodiment;

FIG. 6 is a flowchart illustrating an operation of blocking electromagnetic waves according to an embodiment;

FIG. 7 is a flowchart illustrating an operation of blocking electromagnetic waves according to an embodiment; and

FIG. 8 is a flowchart illustrating a warning output operation according to an embodiment.

### DETAILED DESCRIPTION

Hereinafter, the embodiments disclosed in the present specification will be described in detail with reference to the accompanying drawings. The same or similar elements are denoted by the same reference numerals even though they are depicted in different drawings, and redundant descriptions thereof will be omitted. With regard to the description of the drawings, similar reference numerals may be used to refer to similar or related elements.

In the following description, with respect to constituent elements used in the following description, the suffixes “module” and “unit” are used only in consideration of facilitation of description, and do not have mutually distinguished meanings or functions. As used herein, the suffix “module” or “unit” may include a unit implemented in hardware, software, or firmware, and may be used interchangeably with other terms, for example, “logic,” “logic block,” “part,” or “circuitry.” A “module” or a “unit” may be a single integral component, or a minimum unit or part thereof, adapted to perform one or more functions. For example, the “module” or the “unit” may be implemented in the form of an application-specific integrated circuit (ASIC).

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and spirit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Embodiments as set forth herein may be implemented as software including one or more instructions that are stored in a storage medium (e.g., a memory) that is readable by a machine (e.g., the aerosol-generating device 1). For example, a processor (e.g., the processor 170) of the machine (e.g., the aerosol-generating device 1) may invoke at least one of the one or more instructions stored in the storage medium, and may execute the same. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

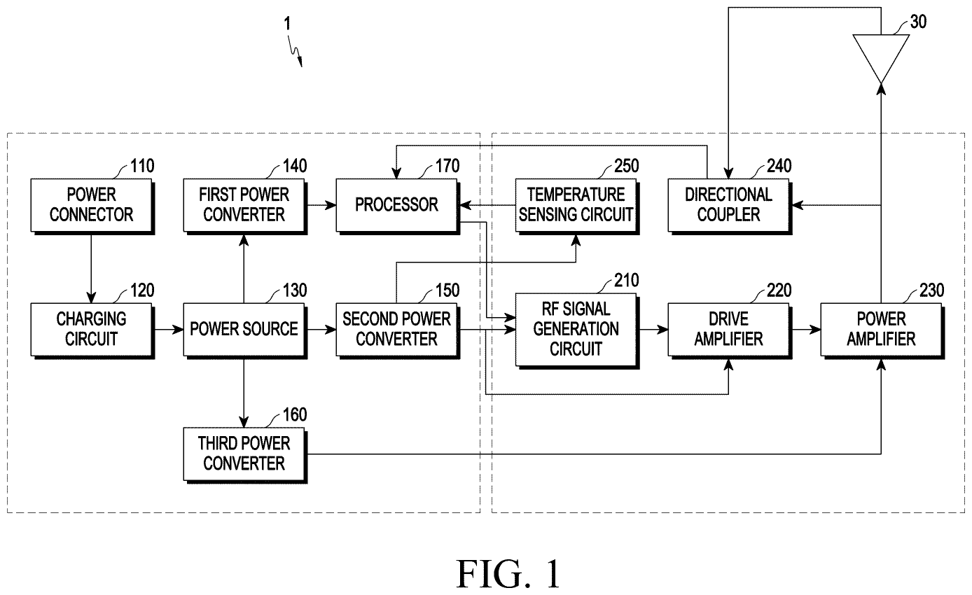

FIG. 1 is a block diagram of an aerosol-generating device according to an embodiment.

According to an embodiment, the aerosol generation device 1 may include a controller 10, a source unit 20, and a radiating unit 30. The controller 10 may refer to a circuit for controlling the basic operation of the aerosol generation device 1. The source unit 20 may refer to a circuit for generating radio frequency (RF) signals under the control of the controller 10. The radiating unit 30 may be a device for radiating the RF signals generated by the source unit 20 in the form of electromagnetic waves into space (hereinafter, an insertion space) into which an aerosol-generating article is inserted. The charges or ions in a dielectric (e.g., glycerin) included in the aerosol-generating article may vibrate or rotate due to the radiated electromagnetic waves (e.g., RF signals), and the dielectric may generate heat due to the frictional heat generated during the vibration or rotation of the charges or ions, thereby heating the aerosol-generating article. In other words, the aerosol generation device 1 may be a device that generates aerosol by heating the aerosol-generating article in a dielectric heating manner.

In an example, the controller 10 may include a power connector 110, a charging circuit 120, a power source 130, a first power converter 140, a second power converter 150, a third power converter 160, and/or a processor 170. In addition, the source unit 20 may include an RF signal generation circuit 210, a drive amplifier 220, a power amplifier 230, a directional coupler 240, and/or a temperature sensing circuit 250. However, those skilled in the art will understand that, depending on the design of the aerosol generation device 1, some of the components illustrated in FIG. 1 may be excluded or new components may be added thereto.

The power connector 110 may refer to a physical connection device that is electrically connected to an external electronic device or system (e.g., external power source) outside the aerosol generation device 1 and transmits/receives power. For example, the power connector 110 may receive power from an external power source, and transmit the received power to the component (e.g., the power source 130) that requires charging. The power connector 110 may also provide a path for data transmission. The aerosol generation device 1 may transmit and receive data to and from an external electronic device or system (e.g., smartphones, computers, etc.) through the power connector 110. The power connector 110 may include a universal serial bus (USB) power connector, a direct current (DC) power connector, or the like. In an example, the power connector 110 may be a USB-C type connector capable of supplying a direct current (DC) voltage of 9V at a current of 1A, but is not necessarily limited thereto. The power connector 110 may include an interface for wirelessly transmitting and receiving power.

The charging circuit 120 may refer to a circuit for charging the power source 130. The charging circuit 120 may charge the power source 130 using power delivered from the power connector 110. In an example, the charging circuit 120 may be implemented as a charger IC that is an integrated circuit (IC) for performing functions for efficiently and safely charging the power source 130. The charging circuit 120 may monitor the charging status of the power source 130 or optimize the charging process by monitoring the voltage, current, and/or temperature of the power source 130. For example, the charging circuit 120 may prevent overcharging or overdischarging by detecting the status of the power source 130 and providing an appropriate charging voltage and current.

The power source 130 may supply power for the operation of the aerosol generation device 1. The power source 130 may include one or more rechargeable batteries. The power source 130 may supply power to the radiating unit 30 such that the radiating unit 30 may radiate electromagnetic waves (e.g., RF signals) into the insertion space, thereby heating the aerosol-generating article. Here, the power supply to the radiating unit 30 may have the same meaning as the power supply to the source unit 20. In addition, the power source 130 may supply power required for the operation of the processor 170, the RF signal generation circuit 210, the drive amplifier 220, the power amplifier 230, and the temperature sensing circuit 250. In an example, the power source 130 may be the lithium polymer (LiPoly) battery, but it is not limited thereto. The power source 130 may be a replaceable (detachable) battery (hereinafter, a removable battery). The removable battery may be mounted in the battery compartment provided inside the aerosol generation device 1, or removed from the battery compartment. The removable battery may be charged through wired and/or wireless charging.

The aerosol generation device 1 may include a power conversion circuit for converting power supplied from the power source 130 into power (e.g., voltage and/or current) suitable for other components. The power conversion circuit may include at least one of a buck converter, a buck-boost converter, a boost converter, the Zener diode, and a low-dropout (LDO) regulator. In addition, the power conversion circuit may include a DC/AC converter (e.g., inverter) as needed.

In an example, the aerosol generation device 1 may include a first power converter 140, a second power converter 150, and a third power converter 160. The first power converter 140 may be an LDO regulator for supplying power (e.g., DC 3.3V) suitable for the processor 170, the second power converter 150 may be a buck-boost converter for supplying power (e.g., DC 5V) suitable for the temperature sensing circuit 250, the RF signal generation circuit 210, and the drive amplifier 220, and the third power converter 160 may be a boost converter for supplying power (e.g., DC 12V /25W) suitable for the power amplifier 230.

However, the first power converter 140, the second power converter 150, and the third power converter 160 are not limited to the examples described above, and may include other types of power conversion circuits. In addition, although FIG. 1 illustrates that the aerosol generation device 1 includes three power converters, the aerosol generation device 1 may include more or fewer power converters than three. In an example, at least a part of the first power converter 140, the second power converter 150, and the third power converter 160 may be integrated into a single power converter.

The processor 170 may control the overall operation of the aerosol generation device 1. For example, the processor 170 may directly or indirectly control the charging and discharging of the power source 130 using the charging circuit 120. In addition, the processor 170 may control the voltage and/or current output from the power conversion circuit by adjusting the frequency and/or duty ratio of the current pulse input to at least one switching element of the power conversion circuit. In addition to the components described above, the processor 170 may further control the overall operation of other components described below.

The processor 170 may be implemented as an array of multiple logic gates, or may be implemented as a combination of a general-purpose microcontroller unit (MCU) (or microprocessor) and memory that stores programs executable on the MCU. In addition, those skilled in the art may understand that the processor 170 may be implemented as other types of hardware.

The RF signal generation circuit 210 may generate RF signals, based on power delivered from the power source 130 or second power converter 150. The RF signal may refer to a signal having a frequency in the range of 300 MHz to 300 GHz. In an example, the RF signal may have a frequency of 1 GHz to 100 GHz. In addition, the RF signal may have a frequency within the Industrial Scientific and Medical Equipment (ISM) band, for example, 915 MHz, 2.45 GHz, and/or 5.8 GHz.

The RF signal generation circuit 210 may include a voltage controlled oscillator (VCO) that generates RF signals with different frequencies depending on the input voltage. The RF signal generation circuit 210 may receive a control signal (e.g., DC signal) from the processor 170 and generate an RF signal with a frequency corresponding to the received control signal. The processor 170 may store the control signal corresponding to the desired frequency in the form of a look-up table, or calculate the control signal corresponding to the desired frequency in real time through at least one operation.

In an example, the aerosol generation device 1 may further include a digital-to-analog converter (D/A converter) for converting a digital control signal output from the processor 170 into an analog control signal. The RF signal generation circuit 210 may receive the analog control signal and generate an RF signal having a frequency corresponding to the analog control signal received.

The drive amplifier 220 may amplify the RF signal generated by the RF signal generation circuit 210. For example, the drive amplifier 220 may provide an appropriate input signal to a subsequent component (e.g., the power amplifier 230) by amplifying the signal level (e.g., amplitude) of the RF signal. The drive amplifier 220 may minimize signal distortion by maintaining high linearity. However, since the drive amplifier 220 is an amplifier focused on increasing the signal level, it may provide relatively low output power.

The power amplifier 230 may amplify the power of an RF signal received from the drive amplifier 220. The power amplifier 230 may be an amplifier focused on providing sufficient power to the final output device (e.g., the radiating unit 30). For example, the power amplifier 230 may provide an RF signal with high power to the radiating unit 30 such that the radiating unit 30 is able to radiate electromagnetic waves into the insertion space to heat the aerosol-generating article. The power amplifier 230 may perform an amplification operation using power received through the third power converter 160 that provides higher power and/or voltage than the second power converter 150.

The drive amplifier 220 and the power amplifier 230 may include transistors such as the bipolar junction transistor (BJT), the field effect transistor (FET), or the like, or vacuum tubes. In an example, although the drive amplifier 220 and the power amplifier 230 may be gallium-nitride (GaN) transistors capable of handling high voltage at high efficiency and high speed, they are not necessarily limited thereto. The drive amplifier 220 and the power amplifier 230 may further include an operational amplifier.

Meanwhile, although the drive amplifier 220 and the power amplifier 230 are illustrated as individual amplifiers in FIG. 1, the drive amplifier 220 and the power amplifier 230 may be integrated into a single amplifier. In addition, the drive amplifier 220 and/or the power amplifier 230 may be configured as a series connection, a parallel connection, and/or a combination of both with multiple amplifiers.

The radiating unit 30 may include at least one antenna for radiating electromagnetic waves into space. At least one antenna may have a size and shape suitable for the size and shape of the aerosol-generating article. For example, if the aerosol-generating article is cylindrical, at least one antenna may be tubular to enclose the cylindrical aerosol-generating article. The tubular shape of the antenna may indicate that the overall shape of the antenna is tubular. In other words, if the antenna is formed of a metal (e.g., SUS) track, the overall shape of the entire track may be tubular. The shape of at least one antenna is not limited to the example described above and may include various shapes such as a flat plate shape, a curved plate shape, or the like.

The radiating unit 30 may radiate electromagnetic waves (e.g., amplified RF signals or transmitted RF signals) into the insertion space, thereby heating the aerosol-generating article. In order to maximize the heating efficiency of the aerosol-generating article, the resonance of the electromagnetic waves must occur inside the insertion space. The resonance conditions (e.g., resonant frequency) of the insertion space may vary depending on the amount of dielectric material included in the aerosol-generating article inserted or the like. The processor 170 may control the frequency of the RF signal generated by the RF signal generation circuit 210 to correspond to or approach the resonance conditions of the insertion space by adjusting the control signal input to the RF signal generation circuit 210. The processor 170 may use the directional coupler 240 to obtain information about the resonance conditions of the insertion space.

The directional coupler 240 may refer to a passive element having a waveguide structure capable of separating incident waves and reflected waves. The directional coupler 240 may receive an RF signal transmitted from the power amplifier 230 toward the radiating unit 30, and an electromagnetic waves radiated by the radiating unit 30 and then reflected from the insertion space, respectively. The directional coupler 240 may separate the transmitted RF signals and the reflected electromagnetic waves, and transmit them the processor 170.

In an example, the aerosol generation device 1 may further include an analog-to-digital (A/D) converter for converting an analog output of the directional coupler 240 into a digital output. The A/D converter may be built into the processor 170 or may be a separate component outside the processor 170. The processor 170 may monitor the output of the directional coupler 240 to analyze the characteristics (e.g., current, voltage, power, phase, and/or frequency) of the transmitted RF signal and the characteristics (e.g., current, voltage, power, phase, and/or frequency) of the reflected electromagnetic waves.

The processor 170 may identify whether or not the source unit 20 is operating as intended, based on the characteristics of the transmitted RF signal. In addition, the characteristics of the transmitted RF signal, along with the characteristics of the reflected electromagnetic wave, may be used to determine the heating efficiency of the source unit 20 or radiating unit 30. The processor 170 may control the source unit 20 such that the heating efficiency of the source unit 20 or the radiating unit 30 is maximized. For example, the processor 170 may adjust the frequency of the RF signal generated by the RF signal generation circuit 210 such that the power of the reflected electromagnetic wave is minimized. The power of the reflected electromagnetic wave being minimized may indicate that the frequency of the RF signal approaches the resonance conditions of the insertion space. The characteristics of the transmitted RF signal may provide the criterion for determining whether or not the power of the reflected electromagnetic wave is minimized.

Since the resonance of the electromagnetic wave may occur in the insertion space depending on the frequency of the RF signal, the insertion space may be referred to as a “resonance section.” At least a portion of the insertion space may be surrounded by at least one shielding member in order to prevent the electromagnetic waves from leaking outside the aerosol generation device 1. According to an embodiment, the insertion space may further include a physical structure for ensuring that the resonance conditions fall within the controllable range of the processor 170. The physical structure may include at least one conductor, and the resonance conditions of the insertion space may vary depending on the arrangement, thickness, and length of the conductor. In addition, the physical structure may include a space for accommodating a dielectric with low electromagnetic wave absorption, which is separate from the dielectric included in the aerosol-generating article. The dielectric with low electromagnetic wave absorption may change the resonant frequency of the entire resonant section without absorbing energy that is to be transferred to a heated object. Accordingly, even if the resonant section is miniaturized, the resonance conditions may be determined to fall within the controllable range by the processor 170.

The temperature sensing circuit 250 may be disposed in contact with or adjacent to the components included in the source unit 20, thereby measuring the temperature of the source unit 20. For example, the temperature sensing circuit 250 may be disposed in contact with or adjacent to at least one of the RF signal generation circuit 210, the drive amplifier 220, and the power amplifier 230. Heat may be generated due to limited efficiency during the generation and/or amplification of an RF signal, and if excessive heat is generated, the components included in the source unit 20 or other components included in the aerosol generation device 1 may receive negative effects. The temperature measured by the temperature sensing circuit 250 may be utilized to prevent the overheating of the source unit 20.

The processor 170 may receive the temperature measured (or a value corresponding to the temperature) from the temperature sensing circuit 250 and, if it is determined that the source unit 20 has overheated, suspend the operation of the source unit 20. For example, the processor 170 may suspend the operation of the source unit 20 by shutting off the power supply to the source unit 20 or by transmitting a control signal. Hereinafter, the term “supplying power to the source unit 20” indicates controlling whether or not to operate the source unit 20.

The temperature sensing circuit 250 may include at least one temperature sensor, such as a thermocouple, a resistance temperature detector (RTD), a thermistor, a semiconductor temperature sensor, or an optical temperature sensor. In an example, the temperature sensing circuit 250 may be implemented as a chip-type sensor (e.g., negative temperature coefficient (NTC) sensor) in order to minimize the area occupied, but is not necessarily limited thereto.

Meanwhile, the aerosol generation device 1 may further include other components in addition to the components illustrated in FIG. 1. For example, the aerosol generation device 1 may further include a sensor unit, an output unit, an input unit, a communication unit, and memory. In addition, if the aerosol generation device 1 is a hybrid-type device that uses both an aerosol-generating article and a cartridge, the aerosol generation device 1 may further include a cartridge heater. The cartridge heater may receive power from the power source 130 and heat the medium and/or aerosol-generating material inside the cartridge.

According to an embodiment, the sensor unit may detect the status of the aerosol generation device 1 or the surrounding status of the aerosol generation device 1, and transmit detected information to the processor 170. For example, the sensor unit may include a temperature sensor, a puff sensor, an insertion detection sensor, a reuse detection sensor, an over-humidity detection sensor, a cigarette identification sensor, a cartridge detection sensor, a cap detection sensor, and/or a movement detection sensor. Meanwhile, the sensor unit may further include various sensors such as a liquid level sensor for detecting the liquid level in the cartridge and a submersion sensor for detecting the submersion of the aerosol generation device 1.

According to an embodiment, the temperature sensor may detect the temperature of the insertion space or the aerosol-generating article. The temperature sensor may be disposed in contact with or adjacent to the insertion space or the aerosol-generating article to directly measure the temperature of the insertion space or the aerosol-generating article. Alternatively, the temperature sensor may be disposed to be spaced apart from the insertion space or the aerosol-generating article to indirectly (e.g., non-contact) measure the temperature of the insertion space or the aerosol-generating article. In an example, the temperature sensor may include an optical temperature sensor (e.g., an infrared temperature sensor).

According to an embodiment, the temperature sensor may detect the temperature of the power source 130. The temperature sensor may be disposed adjacent to the power source 130. For example, the temperature sensor may be attached to one surface of the power source 130 (e.g., battery) and/or mounted on one surface of a printed circuit board. For example, the aerosol generation device 1 may include a power source protection circuit module (PCM), and the temperature sensor may be disposed adjacent to the power source 130 along with the power source protection circuit module.

According to an embodiment, the temperature sensor may be disposed inside a housing (not shown) of the aerosol generation device 1 to detect the temperature inside the housing (not shown).

According to an embodiment, the puff sensor may detect the user's puff.

For example, the puff sensor may include a pressure sensor. The pressure sensor may output a signal corresponding to the internal pressure of the aerosol generation device 1, and the processor 170 may detect the user's puff, based on the signal corresponding to the internal pressure. Here, the internal pressure of the aerosol generation device 1 may correspond to the pressure of an airflow path through which gas flows. The puff sensor may be disposed corresponding to the airflow path through which gas flows in the aerosol generation device 1.

As another example, the puff sensor may include a temperature sensor. When a user puffs, a temporary temperature drop may occur in the airflow path, insertion space, or aerosol-generating article. The processor 170 may detect the user's puff, based on a signal corresponding to the temperature of the airflow path output from the temperature sensor.

As another example, the puff sensor may include both a pressure sensor and a temperature sensor. In this case, the temperature sensor may measure the temperature used to correct the internal pressure measured by the pressure sensor. As an example, the puff sensor may correct a signal corresponding to the internal pressure, based on the temperature measured by the temperature sensor, and output the corrected signal. As another example, the puff sensor may output a signal corresponding to the temperature measured by the temperature sensor and a signal corresponding to the internal pressure measured by the puff sensor. In this case, the processor 170 may receive these signals and correct the signal corresponding to the internal pressure, based on the signal corresponding to the temperature.

As another example, the puff sensor may include a capacitive sensor. In the disclosure, the capacitive sensor may also be referred to as a “cap sensor.” When a user puffs, a temperature change and/or aerosol flow may occur inside the insertion space, which may change the permittivity inside the insertion space. The processor 170 may detect the user's puff, based on a signal corresponding to the permittivity inside the insertion space, which is output from the capacitive sensor.

The puff sensor is not limited to the examples described above and may be implemented using various sensors for detecting the user's puff.

According to an embodiment, the insertion detection sensor may detect the insertion and/or removal of an aerosol-generating article. The insertion detection sensor may be installed around the insertion space.

For example, the insertion detection sensor may include a capacitive sensor. The capacitive sensor may include at least one conductor, and the at least one conductor may be disposed adjacent to the insertion space. When an aerosol-generating article is inserted into or removed from the insertion space, the permittivity around the conductor may change. The processor 170 may detect the insertion and/or removal of the aerosol-generating article, based on a signal corresponding to the permittivity inside the insertion space, which is output from the capacitive sensor.

As another example, the insertion detection sensor may include an inductive sensor. The inductive sensor may include at least one coil, and the at least one coil may be disposed adjacent to the insertion space. When the aerosol-generating article (e.g., the wrapper of the aerosol-generating article) includes a conductor, when the aerosol-generating article is inserted into or removed from the insertion space, a change in the magnetic field may occur around the current-carrying coil. The processor 170 may detect the insertion and/or removal of an aerosol-generating article including a conductor, based on the characteristics of the current (e.g., frequency, current value, voltage value, inductance value, or impedance value of the AC current) output from or detected by the inductive sensor. Alternatively, the aerosol-generating article (e.g., the medium portion of the aerosol-generating article) may include a susceptor (SUS) or the like. In this case, a change in the magnetic field may occur around the coil, based on the insertion or removal of the susceptor inside the insertion space, and the processor 170 may detect the insertion and/or removal of the aerosol-generating article, based on the characteristics of the current from the inductive sensor.

The insertion detection sensor is not limited to the examples described above and may be implemented as various sensors (e.g., proximity sensors, etc.) for detecting the insertion and/or removal of the aerosol-generating article. According to an embodiment, the insertion detection sensor may include a switch or the like for detecting compression by the aerosol-generating article.

According to an embodiment, the reuse detection sensor may detect whether the aerosol-generating article is reused. For example, the reuse detection sensor may be a color sensor for detecting the color of the aerosol-generating article. When an aerosol-generating article is used by a user, a color change may occur in a portion of the wrapper surrounding the outer surface of the aerosol-generating article due to the generated aerosol or heating. The color sensor may output a signal corresponding to the optical characteristics (e.g., wavelength of light) corresponding to the color of the wrapper, based on light reflected from the wrapper. If a color change is detected in a portion of the wrapper, the processor 170 may determine that the aerosol-generating article inserted into the insertion space has already been used.

According to an embodiment, the over-humidity detection sensor may detect whether the aerosol-generating article is excessively humidified. For example, the over-humidity detection sensor may include a capacitive sensor. The capacitive sensor may include at least one conductor disposed adjacent to the insertion space. The processor 170 may detect whether the aerosol-generating article is excessively humidified based on the level of a signal corresponding to the permittivity or the like output from the capacitive sensor. For example, the processor 170 may identify the range of levels within which the signal level falls based on a look-up table and determine the moisture content of the aerosol-generating article, based on the determined range of levels.

According to an embodiment, the cigarette identification sensor may detect whether the aerosol-generating article is genuine, and/or may detect the type of the aerosol-generating article.

For example, the cigarette identification sensor may include an optical sensor for detecting an identification material (or identification mark) located on the outer surface (e.g., wrapper) of the aerosol-generating article. The optical sensor may emit light toward the identification material (or identification mark) of the aerosol-generating article and detect the authenticity and/or type of the aerosol-generating article, based on the reflected light. For example, the identification material may include a material that emits light at a specific wavelength band, based on the emitted light. The processor 170 may detect the authenticity and/or type of the aerosol-generating article, based on the wavelength range.

As another example, the cigarette identification sensor may include a capacitive sensor. The permittivity inside the insertion space may vary depending on the type of aerosol-generating article inserted into the insertion space. The processor 170 may detect the authenticity and/or type of the aerosol-generating article, based on a signal corresponding to the permittivity inside the insertion space, which is output from the capacitive sensor.

As another example, the cigarette identification sensor may include an inductive sensor. When the wrapper and/or interior (e.g., medium portion) of the aerosol-generating article inserted into the insertion space includes a conductor, the characteristics of the current (e.g., frequency, current value, voltage value, inductance value, or impedance value of the AC current) detected by the inductive sensor, when the aerosol-generating article is inserted into the insertion space, may vary depending on the type of aerosol-generating article inserted into the insertion space. The processor 170 may detect the authenticity and/or type of the inserted aerosol-generating article, based on the characteristics of the current output from or detected by the inductive sensor.

The cigarette identification sensor is not limited to the examples described above and may be implemented as various sensors for detecting the authenticity of the aerosol-generating article and/or the type of the aerosol-generating article. In addition, the cigarette identification sensor may include any combination of the examples described above.

According to an embodiment, the cartridge detection sensor may detect the mounting and/or removal of a cartridge. For example, the cartridge detection sensor may include an inductive sensor, a capacitive sensor, a resistive sensor, a Hall sensor (Hall IC), and/or an optical sensor.

According to an embodiment, the cap detection sensor may detect the mounting and/or removal of a cap. For example, the cap detection sensor may include an inductive sensor, a capacitive sensor, a resistive sensor, a contact sensor, a Hall sensor (Hall IC), and/or an optical sensor. The cap may include a structure that covers at least a portion of a cartridge mounted or inserted into the aerosol generation device 1 or covers at least a portion of the housing of the aerosol generation device 1. The cap detection sensor may output a signal corresponding to the mounting or removal when the cap is mounted to or removed from the housing, and the processor 170 may detect the mounting or removal of the capable of, based on the signal corresponding to the mounting or removal.

According to an embodiment, the movement detection sensor may detect the movement of the aerosol generation device 1. The movement detection sensor may be implemented as at least one of an acceleration sensor or a gyro sensor.

According to an embodiment, in addition to the aforementioned sensors, the sensor unit may further include at least one of a humidity sensor, a barometric pressure sensor, a geomagnetic sensor, a global positioning system (GPS), or a proximity sensor. Since the functions of the respective sensors may be intuitively inferred from their names by those skilled in the art, a detailed description thereof will be omitted.

According to an embodiment, the output unit may output information regarding the status of the aerosol generation device 1. The output unit may include, but is not limited to, a display, a haptic unit, and/or an audio output unit. For example, information about the aerosol generation device 1 may include the charging/discharging status of the power source 130 of the aerosol generation device 1, the operating status of the source unit 20 or the radiating unit 30, the insertion/removal status of the aerosol-generating article and/or cartridge, the mounting and/or removal status of the cap, or a status restricts the use of the aerosol generation device 1 (e.g., detection of an abnormal item). The display may visually provide information about the status of the aerosol generation device 1 to the user. For example, the display may include a light-emitting diode (LED) element, a liquid crystal display (LCD), an organic light-emitting diode (OLED) display panel, or the like. The display may also be used as an input unit when it includes a touchpad. The haptic unit may tactilely provide information about the status of the aerosol generation device 1 to the user. For example, the haptic unit may include a vibration motor, a piezoelectric element, an electrical stimulation device, and the like. The audio output unit may provide auditory information about the aerosol generation device 1 to the user. For example, the audio output unit may convert an electrical signal into an audio signal and output it to the outside.

According to an embodiment, the input unit may receive information input from the user. For example, the input unit may include a touch panel, a button, a keypad, a dome switch, a jog wheel, a jog switch, or the like.

According to an embodiment, the memory is hardware that stores various data processed in the aerosol generation device 1, and may store data processed and data to be processed by the processor 170. For example, the memory may include at least one type of storage medium among a flash memory type, a hard disk type, a multimedia card micro type, card type memory (e.g., SD or XD memory, etc.), random access memory (RAM), static random access memory (SRAM), read-only memory (ROM), electrically erasable programmable read-only memory (EEPROM), programmable read-only memory (PROM), magnetic memory, a magnetic disk, and an optical disk. For example, the memory may store the operating time of the aerosol generation device 1, the maximum number of puffs, the current number of puffs, at least one temperature profile, and data on the user's smoking pattern.

According to an embodiment, the communication unit may include at least one component for communicating with another electronic device (e.g., a portable electronic device). For example, the communication unit may include a Bluetooth communication unit, a Bluetooth Low Energy (BLE) communication unit, a near-field communication unit, a wireless local area network (WLAN) communication unit, a Zigbee communication unit, an Infrared Data Association (IrDA) communication unit, a Wireless Fidelity Direct (WFD) communication unit, an ultra-wideband (UWB) communication unit, an Adaptive Network Topology (ANT) communication unit, a cellular network communication unit, an Internet communication unit, a computer network (e.g., LAN or WAN) communication unit, and the like.

According to an embodiment, the processor 170 may control the temperature of the insertion space or the aerosol-generating article by controlling the amplification factor of the source unit 20 (e.g., the power amplifier 230). The processor 170 may control the amplification factor of the source unit 20 (e.g., the power amplifier 230), based on the temperature of the insertion space or aerosol-generating article detected using the temperature sensor. The processor 170 may control the amplification factor of the source unit 20 (e.g., the power amplifier 230), based on a temperature profile and/or power profile stored in the memory.

In addition, the processor 170 may control the temperature of the cartridge heater by controlling the power supply from the power source 130 to the cartridge heater. The processor 170 may control the temperature of the cartridge heater and/or the power supplied to the cartridge heater, based on the temperature of the cartridge heater detected using the temperature sensor. The processor 170 may control the temperature of the cartridge heater and/or the power supplied to the cartridge heater, based on a temperature profile and/or power profile stored in the memory.

According to an embodiment, the processor 170 may prevent the insertion space, the aerosol-generating article, and/or the cartridge heater from overheating. For example, the processor 170 may control the operation of the power conversion circuit, based on the temperatures of the insertion space, aerosol-generating article, and/or cartridge heater exceeding a preset threshold temperature, to reduce the amount of power supplied to the source unit 20 or the cartridge heater or to stop supplying power to the source unit 20 or the cartridge heater.

According to an embodiment, the processor 170 may control the power supply to the source unit 20 or the cartridge heater, based on the results sensed by the sensor unit.

According to an embodiment, the processor 170 may control the power supply to the source unit 20 or the cartridge heater, based on the insertion and/or removal of the aerosol-generating article to and/or from the insertion space. For example, if it is determined that an aerosol-generating article has been inserted into the insertion space using the insertion detection sensor, the processor 170 may control the power supply to the source unit 20 or the cartridge heater. If it is determined that the aerosol-generating article has been removed from the insertion space using the insertion detection sensor, the processor 170 may cut off the power supply to the source unit 20 or the cartridge heater. The processor 170 may also determine that the aerosol-generating article has been removed from the insertion space if the temperature of the insertion space or aerosol-generating article is greater than or equal to a threshold temperature or if the temperature change gradient of the insertion space or aerosol-generating article is greater than or equal to a configured gradient.

According to an embodiment, the processor 170 may control power supply time and/or power supply amount to the source unit 20 or the cartridge heater, based on the status of the aerosol-generating article. For example, if the processor 170 determines that the aerosol-generating article is excessively humidified using the over-humidity detection sensor, it may increase the power supply time (e.g., preheating time) with respect to the source unit 20 or the cartridge heater.

According to an embodiment, the processor 170 may control the power supply to the source unit 20 or the cartridge heater, based on whether the aerosol-generating article is reused. For example, if it is determined that the aerosol-generating article has been used, the processor 170 may cut off the power supply to the source unit 20 or the cartridge heater.

According to an embodiment, the processor 170 may control the power supply to the source unit 20 or the cartridge heater, based on whether the cartridge is attached and/or removed. For example, if it is determined that the cartridge is separated using the cartridge detection sensor, the processor 170 may suspend the power supply to the source unit 20 or the cartridge heater, or control power not to be supplied to the source unit 20 or the cartridge heater.

According to an embodiment, the processor 170 may control the power supply to the source unit 20 or the cartridge heater, based on whether the aerosol-generating material in the cartridge has been exhausted. For example, if it is determined that the temperature of the cartridge heater exceeds a threshold temperature while preheating the cartridge heater (i.e., during the preheating period), the processor 170 may determine that the aerosol-generating material in the cartridge has been exhausted. If it is determined that the aerosol-generating material in the cartridge has been exhausted, the processor 170 may cut off power supply to the source unit 20 or the cartridge heater.

According to an embodiment, the processor 170 may control the power supply to the source unit 20 or the cartridge heater, based on the availability of the cartridge. For example, the processor 170 may determine that the cartridge is unusable if the current number of puffs is determined to be greater than or equal to the maximum number of puffs configured for the cartridge, based on data stored in the memory. Alternatively, the processor 170 may determine that the cartridge is unusable if the total time the cartridge heater has been heated is greater than or equal to a preset maximum time or if the total amount of power supplied to the cartridge heater is greater than or equal to a preset maximum power. In this case, the processor 170 may suspend power supply to the source unit 20 or the cartridge heater, or control power not to be supplied to the source unit 20 or the cartridge heater.

According to an embodiment, the processor 170 may control the power supply to the source unit 20 or the cartridge heater, based on a user's puff. For example, the processor 170 may use the puff sensor to determine whether a puff has occurred and/or the intensity of the puff. When the number of puffs reaches a preset maximum number of puffs and/or when no puffs are detected for a preset period of time, the processor 170 may cut off power supply to the source unit 20 or the cartridge heater. The processor 170 may also control the power supply to the source unit 20 or the cartridge heater when a puff is detected.

According to an embodiment, the processor 170 may control the power supply to the source unit 20 or the cartridge heater, based on the authenticity and/or type of the aerosol-generating article (or cartridge). For example, the processor 170 may detect the authenticity and/or type of the aerosol-generating article using the cigarette identification sensor. For example, if the aerosol-generating article (or cartridge) is detected as counterfeit, the processor 170 may cut off the power supply to the source unit 20 or the cartridge heater. If the aerosol-generating article (or cartridge) is detected as genuine, the processor 170 may control (e.g., initiate) the power supply to the source unit 20 or the cartridge heater. As another example, the processor 170 may control the power supply to the source unit 20 or the cartridge heater differently depending on the type of the aerosol-generating article (or cartridge). More specifically, the processor 170 may control the amplification factor of the source unit 20 or the temperature and/or power of the cartridge heater, based on a first temperature profile (or a first power profile), when the aerosol-generating article (or cartridge) is detected as a first aerosol-generating article (or a first cartridge), and may control the amplification factor of the source unit 20 or the temperature and/or power of the cartridge heater, based on a second temperature profile (or a second power profile), when it is detected as a second aerosol-generating article (or a second cartridge).

According to an embodiment, the processor 170 may control the output unit, based on a result detected by the sensor unit. For example, when the number of puffs counted using the puff sensor reaches a preset number, the processor 170 may control the output unit to provide visual, tactile, and/or auditory information indicating that the aerosol generation device 1 is about to be terminated. For example, the processor 170 may control the output unit to provide visual, tactile, and/or auditory information about the temperature of the insertion space, the aerosol-generating article, or the cartridge heater.

According to an embodiment, the processor 170, based on the occurrence of a predetermined event, may store and update a history of the event occurring in the memory. For example, the event may include detection of insertion of the aerosol-generating article, initiation of heating of the aerosol-generating article, puff detection, puff termination, overheating detection, detection of overvoltage application to the cartridge heater, termination of heating of the aerosol-generating article, turning on/off the power source of the aerosol generation device 1, initiation of charging of the power source 130, detection of overcharge of the power source 130, termination of charging of the power source 130, and the like, which are performed by the aerosol generation device 1. For example, the event history may include the date and time the event occurred, log data corresponding to the event, and the like. For example, if the predetermined event is the detection of insertion of an aerosol-generating article, the log data corresponding to the event may include data regarding a sensing value of the insertion detection sensor. For example, if the predetermined event is the detection of overheating of the cartridge heater, the log data corresponding to the event may include data regarding the temperature of the cartridge heater, the voltage applied to the cartridge heater, the current flowing through the cartridge heater, and the like.

According to an embodiment, the processor 170 may control the communication unit to establish a communication link with an external device, such as a user's mobile terminal.

According to an embodiment, when authentication data is received from an external device through the communication link, the processor 170 may release restrictions on the use of at least one function (e.g., the heating function) of the aerosol generation device 1. For example, the authentication data may include the user's birthday, a unique number identifying the user, and information on whether the user has completed authentication.

According to an embodiment, the processor 170 may transmit data regarding the status of the aerosol generation device 1 (e.g., the remaining capacity of the power source 130, the operating mode, etc.) to an external device through the communication link. The transmitted data may be output through a display or the like of the external device.

According to an embodiment, when a location search request for the aerosol generation device 1 is received from an external device through the communication link, the processor 170 may control the output unit to perform an operation corresponding to the location search. For example, the processor 170 may control the haptic unit to generate vibration or the display to output an object corresponding to the location search and the end of the search.

According to an embodiment, when firmware data is received from an external device through the communication link, the processor 170 may perform a firmware update.

According to an embodiment, the processor 170 may transmit data regarding sensed values of at least one sensor unit to an external server (not shown) through the communication link, receive, from the server, a learning model generated by learning the sensed values through machine learning, such as deep learning, and store the same. The processor 170 may use the learning model received from the server to perform operations such as determining a user's inhalation pattern, generating a temperature profile, or the like.

Although not shown in FIG. 1, the aerosol generation device 1 may further include a power source protection circuit. The power source protection circuit may include at least one switching element and block the power path to the power source 130 in response to overcharging and/or overdischarging of the power source 130.

The aerosol-generating article mentioned in the disclosure may include at least one aerosol-generating rod (e.g., a medium portion) and at least one filter rod. The radiating unit 30 may be arranged to correspond to at least one aerosol-generating rod, and may be designed differently depending on the arrangement order and/or positions of the aerosol-generating rod and the filter rod. The aerosol-generating rod may include at least one of nicotine, an aerosol-generating material, and additives. For example, the aerosol-generating material may include glycerin (e.g., vegetable glycerin (VG)) and/or propylene glycol (PG), and may also include various other substances. For example, the additives may include a flavoring agent and/or an organic acid, and may also include various other substances. For example, the aerosol-generating rod may include an aerosol-generating substrate (e.g., a sheet) impregnated with a liquid non-tobacco material (e.g., aerosol-generating material and/or nicotine) and/or a solid tobacco material (e.g., leaf tobacco, reconstituted tobacco, etc.). The tobacco material may be included in the aerosol-generating rod in various forms, such as cut filler, granules, or powder. According to an embodiment, the additives in the aerosol-generating rod may include an alkaline substance. Based on the alkaline substance, the nicotine in the tobacco material included in the aerosol-generating rod may have an alkaline pH (e.g., pH 7.0 or higher). In this case, freebase nicotine may be released from the aerosol-generating rod even at low temperatures. According to an embodiment, the aerosol-generating rod may include two or more aerosol-generating rods, each of which may contain tobacco materials and/or non-tobacco materials. Meanwhile, although not shown, at least one aerosol-generating rod and at least one filter rod may be individually and/or integrally wrapped by at least one wrapper. In the disclosure, the aerosol-generating article may also be referred to as a “stick.”

The cartridge mentioned in the disclosure may contain an aerosol-generating material in any of a liquid, solid, gaseous, or gel state. The aerosol-generating material may contain a liquid composition. For example, the liquid composition may be a liquid containing a tobacco-containing material including a volatile tobacco flavor component, or may be a liquid containing a non-tobacco material. Meanwhile, the cartridge may include a reservoir containing an aerosol-generating material and/or a liquid delivery means impregnated with (containing) the aerosol-generating material. For example, the liquid delivery means may include a wick such as cotton fiber, ceramic fiber, glass fiber, or porous ceramic. The cartridge heater may be incorporated into the cartridge as a coil-shaped structure surrounding (or wrapping) the liquid delivery means or as a structure in contact with one side of the liquid delivery means. Alternatively, the cartridge heater may be included in the aerosol generation device 1 that is separable from the cartridge.

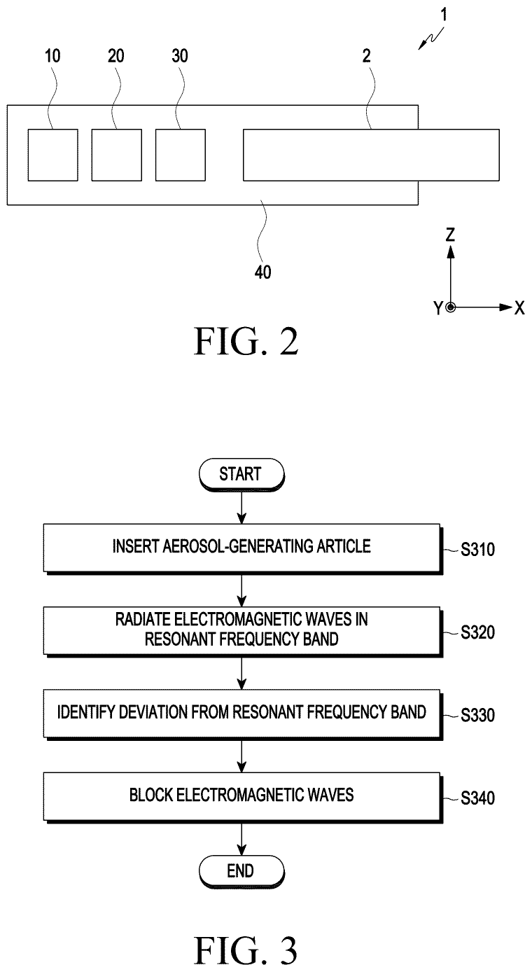

FIG. 2 illustrates an aerosol generation device 1 according to an embodiment.

The controller 10, the source unit 20, the radiating unit 30, and the housing 40 disclosed in FIG. 2 are illustrative examples of components of the aerosol generation device 1, and are not limited to their physical form or configuration order.

Referring to FIG. 2, the aerosol generation device 1 may include a housing 40 including an insertion space. An aerosol-generating article 2 may be inserted into the insertion space. The controller 10 may supply power to the radiating unit 30 through the source unit 20, and the radiating unit 30 may radiate electromagnetic waves into the insertion space of the housing 40 to vibrate the dielectric of the aerosol-generating article 2. As a result, the aerosol-generating article 2 may be heated.

The aerosol generation device 1 in FIG. 2 may operate based on a dielectric heating method using electromagnetic waves. In this case, the electromagnetic waves radiated from the radiating unit 30 may vibrate the dielectric (e.g., glycerin) to generate heat. The dielectric may be included in a portion of the aerosol-generating article 2, which may correspond to the aerosol-generating rod (e.g., the medium portion).

Meanwhile, although FIG. 2 illustrates the electromagnetic waves radiated to a stick-shaped aerosol-generating article 2, the disclosure is not limited thereto, and the aerosol generation device 1 may also be implemented such that electromagnetic waves are radiated to a cartridge containing an aerosol-generating material such as a liquid.

For example, the insertion space may include not only the space into which the aerosol-generating article is inserted in FIG. 2, but also a receiving space into which a cartridge containing an aerosol-generating material (e.g., a liquid or the like) is inserted. In this case, the aerosol-generating material contained in the cartridge may be interpreted as an aerosol-generating article.

The aerosol generation device 1 according to various embodiments of the disclosure may include a frequency out-of-detection (FOD) function. Specifically, the controller 10 may provide a function of detecting in real time whether the frequency inside the insertion space deviates from a preset resonant frequency band and performing appropriate control operations according thereto. The controller 10 may detect frequency band deviations that may occur during the initial insertion of the aerosol-generating article 2 or during the operation of the device, block electromagnetic waves, and output a warning to the user.

Hereinafter, the control operation of the aerosol generation device 1 will be described with reference to FIGS. 3 to 8. Redundant descriptions throughout FIGS. 3 to 8 may be omitted, and at least some of the steps in the flowcharts may be omitted or their sequence may be changed. In addition, operations according to various embodiments of the disclosure may be inserted into any of the steps in the flowcharts.

FIG. 3 is a flowchart illustrating the control operation of an aerosol generation device according to an embodiment.

The controller 10 may detect the insertion of an aerosol-generating article into the aerosol generation device 1 (S310).

The housing of the aerosol generation device 10 may include an insertion space into which an aerosol-generating article is to be inserted. The controller 10 may identify the insertion of an aerosol-generating article into the insertion space through the sensor unit. For example, when an aerosol-generating article is inserted into the housing, the sensor unit may generate a specific signal, or may detect physical contact or an optical change and transmit the detected information to the controller 10.

Next, the controller 10 may radiate electromagnetic waves in a resonant frequency band (S320).

The controller 10 may control the radiating unit 30 to radiate electromagnetic waves to heat the inserted aerosol-generating article 2. For example, the radiating unit 30 may receive power from the source unit 20 and generate electromagnetic waves in a configured resonant frequency band (e.g., any band between 2.4 GHz and 915 MHz), and the generated electromagnetic waves may be transmitted to the insertion space to heat the dielectric material (e.g., medium region) of the aerosol-generating article 2. The electromagnetic waves may be preconfigured to be radiated at a predetermined value depending on the aerosol generation device 1 or the aerosol-generating article 2.

The electromagnetic waves radiated from the radiating unit 30 operate to vibrate the dielectric material, thereby generating heat energy. Heating efficiency may be maximized by maintaining the frequency of the radiated electromagnetic waves within the resonant frequency band.

Next, the controller 10 may identify whether the frequency of the insertion space of the aerosol generation device 1 deviates from the resonant frequency band (S330).

The controller 10 may monitor the status of the electromagnetic waves radiated from the radiating unit 30 in real time, periodically, or at any point in time, thereby determining whether the frequency inside the insertion space remains within the configured resonant frequency band.

For example, the controller 10 may identify the frequency inside the insertion space through various means. For example, the controller 10 may collect data indicating the standing wave ratio (SWR), feedback voltage value, or other resonance status of the electromagnetic waves through the sensor unit. The standing wave ratio indicates the degree of reflection of electromagnetic waves in the insertion space, and if it exceeds a configured threshold, the frequency may be determined to deviate from the resonant frequency band. The feedback voltage value is highest at the resonant frequency, and if this value decreases or exhibits an irregular pattern, it may be considered a frequency deviation. The method for identifying the frequency of the insertion space is not limited thereto, and various methods are available.

The deviation from the resonant frequency band may occur when the aerosol-generating article 2 is initially inserted into the insertion space, or during device operation thereafter. These two cases may arise from different causes and circumstances.

For example, the deviation from the resonant frequency band that occurs from the initial insertion could be due to the insertion of an aerosol-generating article made by a different manufacturer. For example, the dielectric properties (i.e., permittivity) of the relevant article may differ from the resonant frequency band specified for the aerosol generation device 1. As a result, the frequency inside the insertion space may initially deviate from the resonant state.

In addition, if the aerosol-generating article 2 itself is defective (e.g., due to a defect in the internal dielectric material, structural damage, etc.), the configured resonant frequency band cannot be maintained. Meanwhile, if the article is not inserted correctly and is misaligned, the deviation from the resonant frequency band may occur.

On the other hand, the deviation from the resonant frequency band may also occur during operation after the aerosol-generating article 2 is inserted into the insertion space. For example, this may be an event in which the aerosol-generating article 2 is removed from the insertion space. In such a case, the dielectric material may disappear from the insertion space, so that the resonant frequency band may change rapidly.

In particular, if electromagnetic waves continue to irradiate while the aerosol-generating article 2 is removed, there is a risk of safety accidents, such as exposure of the user or the surrounding environment to the electromagnetic waves.

Next, if the controller 10 identifies that the frequency inside the insertion space deviates from the resonant frequency band, it may block the electromagnetic waves (S340).

According to an embodiment, if it is identified that the frequency of the insertion space has deviated from the resonant frequency band, the controller 10 may physically block the emission of electromagnetic waves by cutting off the power supplied to the radiating unit 30 or blocking the opening of the housing 40. In addition, the controller 10 may block electromagnetic waves by forcibly shutting down the entire system power source of the aerosol generation device 1. This will be described in detail later.

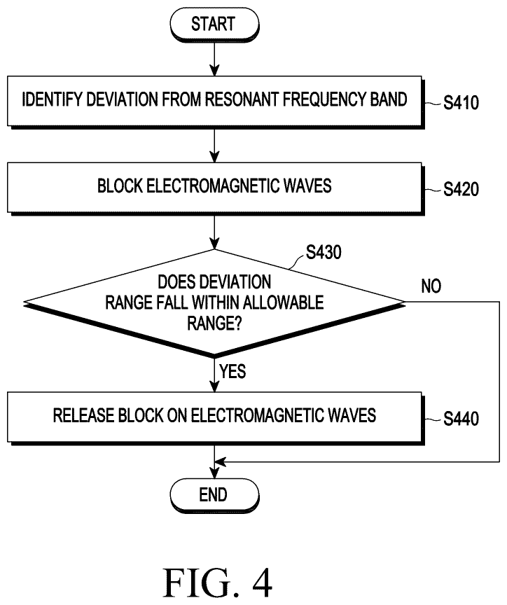

FIG. 4 is a flowchart illustrating the control operation of an aerosol generation device according to an embodiment.

The controller 10 may identify that the frequency of the insertion space has deviated from the resonant frequency band (S410) and block electromagnetic waves (S420). For example, the controller 10 may control the source unit 20 or the radiating unit 30 to immediately block the emission of electromagnetic waves, or forcibly shut down (e.g., turn off) the aerosol generation device 1.

Next, the controller 10 may identify the deviation range indicating how much the frequency inside the insertion space exceeds the resonant frequency band, and determine whether the identified deviation range exceeds an allowable range (S430).

That is, for safety reasons, when the frequency inside the insertion space exceeds the resonant frequency band, electromagnetic waves may be initially blocked, and the process following the blocking may be monitored to determine whether to release the block on the electromagnetic waves.

According to an embodiment, the deviation range may include at least one of the magnitude of the frequency deviating from the resonant frequency band, the time during which the frequency deviates from the resonant frequency band, or the point in time when the frequency deviates from the resonant frequency band.

The controller 10 compares the deviation range with a look-up table or a reference database to determine whether it falls inside the allowable range. For example, if the frequency inside the insertion space exceeds the resonant frequency band for a predetermined period of time (e.g., 5 seconds) or more, or if the magnitude of the exceeding frequency surpasses a preset reference value (e.g., ±50 MHz), the controller 10 may determine that the deviation range falls outside the allowable range (“No” in S430).

On the other hand, if the deviation range falls within the allowable range (“Yes” in S430), the controller 10 may release the block on the electromagnetic waves and resume radiation (S440).

This process may be performed on the assumption that the frequency inside the insertion space has stabilized and restored to a state capable of maintaining the resonant frequency band. For example, when the frequency inside the insertion space normalizes within a predetermined period of time, the controller 10 re-enables the power supplied to the radiating unit 30 so that the device is able to generate aerosols normally.

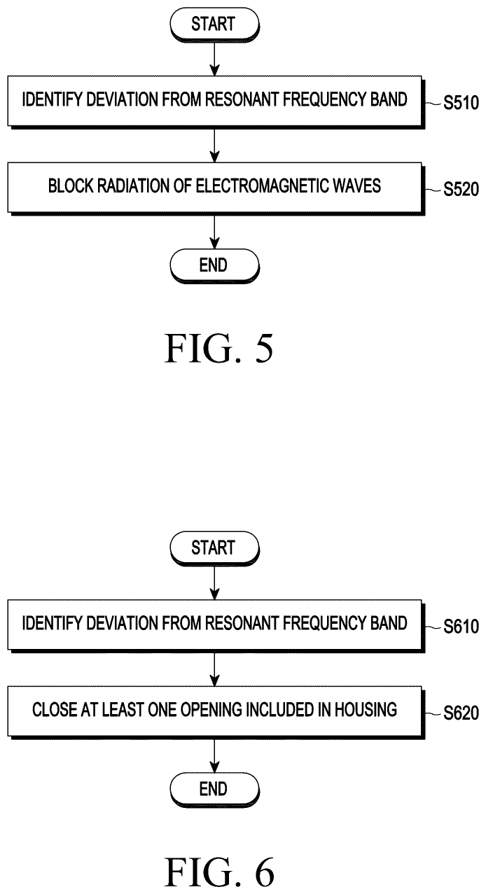

FIG. 5 is a flowchart illustrating an operation of blocking electromagnetic waves according to an embodiment.

The controller 10 may identify that the frequency inside the insertion space has deviated from the resonant frequency band (S510), and then block the electromagnetic waves (S520).

According to an embodiment, the controller 10 may control the source unit 20 to cut off the power supplied to the radiating unit 30. For example, if the frequency inside the insertion space is identified to deviate from a preset resonant frequency band, the controller 10 may transmit a signal to the source unit 20 to suspend the power supply to the radiating unit 30. As a result, the radiation of electromagnetic waves from the radiating unit 30 may be stopped, thereby preventing safety accidents caused by heating in a deviation state from the resonance.

FIG. 6 is a flowchart illustrating an operation of blocking electromagnetic waves according to an embodiment.

The controller 10 may identify that the frequency inside the insertion space has deviated from the resonant frequency band (S610), and then block the electromagnetic waves (S620).

According to an embodiment, the controller 10 may block electromagnetic waves by closing at least one opening included in the housing 40. For example, if the frequency inside the insertion space deviates from the resonant frequency band, the controller 10 may operate a blocking device mounted on the opening of the housing 40 to physically block electromagnetic waves emitted to the outside.

For example, the blocking device may be implemented in the form of a sliding cover, a rotary shutter, or an electronic valve, and may close the lid of the insertion space when the aerosol-generating article 2 is removed from the insertion space. As a result, the emitted electromagnetic waves may be prevented from leaking into the external environment and the user may be protected from electromagnetic waves.

According to an embodiment, the closing of at least one opening described above may be performed upon detection of an event in which the aerosol-generating article 2 is removed (e.g., is separated) from the insertion space. Unlike cases where the aerosol-generating article 2 is defective or from a different manufacturer, if the aerosol-generating article 2 itself is removed, electromagnetic waves may be radiated externally through the insertion space, potentially causing significant harm to the user. In this case, the controller 10 may control the source unit 20 or the radiating unit 30 to block the radiation of electromagnetic waves, and further control the configuration of the aerosol generation device 1 to block at least one opening.

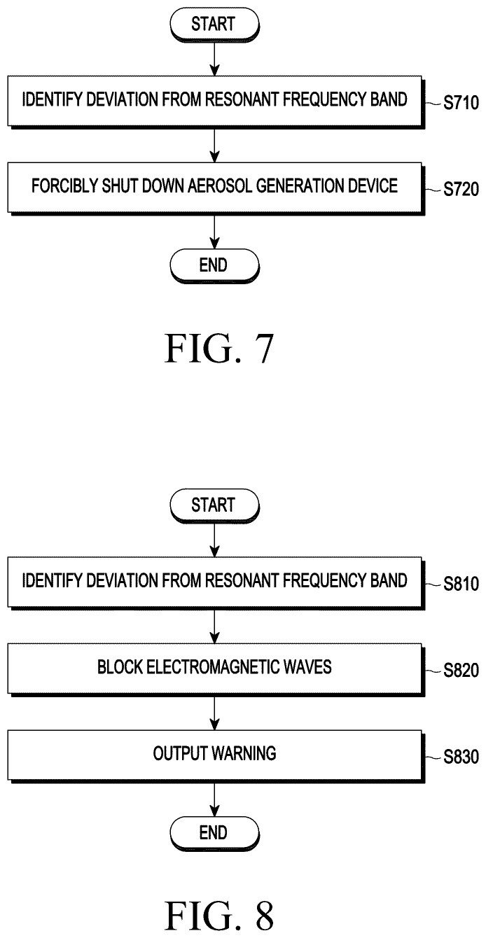

FIG. 7 is a flowchart illustrating an operation of blocking electromagnetic waves according to an embodiment.

The controller 10 may identify that the frequency inside the insertion space has deviated from the resonant frequency band (S710), and then block the electromagnetic waves (S720).

According to an embodiment, the controller 10 may be configured to forcibly shut down the aerosol generation device 1 if the frequency of the insertion space deviates from the resonant frequency band.

For example, if the frequency inside the insertion space deviates from the resonant frequency band, the controller 10 may shut off the power source to the entire system of the aerosol generation device 1, thereby turning the device off. This forced shutdown operation may serve as a preventive measure to prevent overheating, device damage, or safety accidents that may occur in abnormal states.

FIG. 8 is a flowchart illustrating a warning output operation according to an embodiment.

The controller 10 may identify that the frequency inside the insertion space has deviated from the resonant frequency band (S810), and then block the electromagnetic waves (S820). in addition, the controller 10 may output a warning (S830).

For example, the controller 10 may provide a warning in a visual, auditory, or tactile manner. A visual warning may be implemented by flashing an LED lamp or displaying a warning message on a display screen. An auditory warning may notify the user of the current status by generating a warning sound, and a tactile warning may transmit a warning signal to the user through vibration using a vibration motor.

Meanwhile, although the warning output (S830) is illustrated as occurring after the electromagnetic waves are blocked, the warning may be output simultaneously with or even before the electromagnetic waves are blocked.

As described above, the controller 10 may immediately notify the user of the deviation state from the resonant frequency band through the warning output operation, thereby further protecting the user from the risk of electromagnetic wave exposure.

An aerosol generation device according to an embodiment of the disclosure may include a housing including an insertion space into which an aerosol-generating article is insertable, a radiating unit configured to radiate electromagnetic waves into the insertion space to heat the aerosol-generating article, and a processor. Based on a control of the processor, the aerosol generation device is configured to block the electromagnetic waves when a frequency of the insertion space deviates from a preset resonant frequency band.

In the aerosol generation device according to some embodiments of the disclosure, based on a control of the processor, the aerosol generation device may be configured to output a warning when the frequency of the insertion space deviates from the resonant frequency band.

In the aerosol generation device according to some embodiments of the disclosure, the warning may be configured to be output in at least one of a visual, auditory, or tactile form.

In the aerosol generation device according to some embodiments of the disclosure, based on a control of the processor, the aerosol generation device may be configured to cut off power supplied to the radiating unit when the frequency of the insertion space deviates from the resonant frequency band.

In the aerosol generation device according to some embodiments of the disclosure, based on a control of the processor, the aerosol generation device may be configured to block the electromagnetic waves by closing at least one opening included in the housing when the frequency of the insertion space deviates from the resonant frequency band.

In the aerosol generation device according to some embodiments of the disclosure, based on a control of the processor, the aerosol generation device may be configured to forcibly shut down the aerosol generation device when the frequency of the insertion space deviates from the resonant frequency band.

In the aerosol generation device according to some embodiments of the disclosure, based on a control of the processor, the aerosol generation device may be configured to identify a deviation range indicating how much the frequency of the insertion space deviates from the resonant frequency band, and release the block on the electromagnetic waves when the identified deviation range falls within an allowable range.

In the aerosol generation device according to some embodiments of the disclosure, the deviation range may include at least one of a magnitude of a frequency deviating from the resonant frequency band or a time during which the frequency deviates from the resonant frequency band.

A control method according to an embodiment of the disclosure is a control method for an aerosol generation device including a housing including an insertion space into which an aerosol-generating article is insertable, a radiating unit, and a processor, which may include radiating electromagnetic waves into the insertion space to heat the aerosol-generating article, and blocking the electromagnetic waves when a frequency of the insertion space deviates from a preset resonant frequency band.

In the control method according to some embodiments, the method may further include outputting a warning when the frequency of the insertion space deviates from the resonant frequency band.

In the control method according to some embodiments, the blocking of the electromagnetic waves may include cutting off power supplied to the radiating unit.

In the control method according to some embodiments, the blocking of the electromagnetic waves may include closing at least one opening included in the housing.

In the control method according to some embodiments, the blocking of the electromagnetic waves may include forcibly shutting down the aerosol generation device.

In the control method according to some embodiments, the method may further include identifying a deviation range indicating how much the frequency of the insertion space deviates from the resonant frequency band, and releasing the block on the electromagnetic waves when the identified deviation range falls within an allowable range.

In the control method according to some embodiments, the deviation information may include at least one of a magnitude of a frequency deviating from the resonant frequency band, a time during which the frequency deviates from the resonant frequency band, or a point in time when the frequency deviates from the resonant frequency band.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An aerosol generation device comprising:
a housing comprising an insertion space into which an aerosol-generating article is insertable;
a radiating unit configured to radiate electromagnetic waves into the insertion space to heat the aerosol-generating article; and
a processor,
wherein, based on a control of the processor, the aerosol generation device is configured to block the electromagnetic waves when a frequency of the insertion space deviates from a preset resonant frequency band.

2. The aerosol generation device of claim 1,
wherein, based on a control of the processor, the aerosol generation device is configured to output a warning when the frequency of the insertion space deviates from the resonant frequency band.

3. The aerosol generation device of claim 2,
wherein the warning is configured to be output in at least one of a visual, auditory, or tactile form.

4. The aerosol generation device of claim 1,
wherein, based on a control of the processor, the aerosol generation device is configured to cut off power supplied to the radiating unit when the frequency of the insertion space deviates from the resonant frequency band.

5. The aerosol generation device of claim 1,
wherein, based on a control of the processor, the aerosol generation device is configured to block the electromagnetic waves by closing at least one opening included in the housing when the frequency of the insertion space deviates from the resonant frequency band.

6. The aerosol generation device of claim 1,
wherein, based on a control of the processor, the aerosol generation device is configured to forcibly shut down the aerosol generation device when the frequency of the insertion space deviates from the resonant frequency band.

7. The aerosol generation device of claim 1,
wherein, based on a control of the processor, the aerosol generation device is configured to
identify a deviation range indicating how much the frequency of the insertion space deviates from the resonant frequency band, and
release the block on the electromagnetic waves when the identified deviation range falls within an allowable range.

8. The aerosol generation device of claim 7,
wherein the deviation range comprises at least one of a magnitude of a frequency deviating from the resonant frequency band or a time during which the frequency deviates from the resonant frequency band.

9. A control method for an aerosol generation device comprising a housing comprising an insertion space into which an aerosol-generating article is insertable, a radiating unit, and a processor, the control method comprising:
radiating electromagnetic waves into the insertion space to heat the aerosol-generating article; and
blocking the electromagnetic waves when a frequency of the insertion space deviates from a preset resonant frequency band.

10. The control method of claim 9, further comprising
outputting a warning when the frequency of the insertion space deviates from the resonant frequency band.

11. The control method of claim 9,
wherein the blocking of the electromagnetic waves comprises cutting off power supplied to the radiating unit.

12. The control method of claim 9,
wherein the blocking of the electromagnetic waves comprises closing at least one opening included in the housing.

13. The control method of claim 9,
wherein the blocking of the electromagnetic waves comprises forcibly shutting down the aerosol generation device.

14. The control method of claim 9, further comprising:
identifying a deviation range indicating how much the frequency of the insertion space deviates from the resonant frequency band; and
releasing the block on the electromagnetic waves when the identified deviation range falls within an allowable range.

15. The control method of claim 14,
wherein the deviation information comprises at least one of a magnitude of a frequency deviating from the resonant frequency band, a time during which the frequency deviates from the resonant frequency band, or a point in time when the frequency deviates from the resonant frequency band.
